(19) United States
(12) Patent Application Publication
(10) Pub. No.: US 2008/0112602 A1
(43) Pub. Date: May 15, 2008

(54) Medical image generating method

(75) Inventors: Shogo Azemoto, Tokyo (JP); Nobutada Date, Tokyo (JP)

Correspondence Address: OLIFF & BERRIDGE, PLC, P.O. BOX 320850, ALEXANDRIA, VA, 22320-4850, US

(73) Assignee: AZE Ltd., Tokyo (JP)

(21) Appl. No.: 11/979,888

(22) Filed: Nov. 9, 2007

(30) Foreign Application Priority Data
Nov. 13, 2006 (JP) 2006-306808

(51) Int. Cl. G06K 9/00

(52) U.S. Cl. 382/128

(57) ABSTRACT

In the present invention, the difference between regions in which the signal value ranges are close to each other or the presence of overlapping regions of signal values can be clearly displayed on a predetermined image region of an observation image, and the displayed regions and display state thereof can be easily adjusted based on the signal value ranges. The present invention is configured such that a plurality of separate and mutually independent display property curves can be set on the same coordinate system, and a color and a degree of opaqueness, which are established by any number of display property curves from among the plurality of display property curves that are set, can be at once reflected in the image within the region to be observed.

### RELATED APPLICATIONS

This application claims the priority of Japanese Patent Application No. 2006-306808 filed on Nov. 13, 2006, which is incorporated herein by reference.

### BACKGROUND OF THE INVENTION

1. Field of the Invention

The present invention relates to an image generating technology for aiding in image diagnosis, and more particularly to a medical image generating method that can generate an observation image suitable for diagnosis aid based on three-dimensional distribution data of predetermined signal values (computed tomography (CT) values or signal intensity) obtained with an image diagnosis system such as CT, MRI (magnetic resonance imaging), and nuclear medicine.

2. Description of the Prior Art

A technique for configuring images that is known as volume rendering (referred to hereinbelow as “VR”) has been widely used in recent years in image diagnosis systems. VR is a technique for directly visualizing physical quantities associated with coordinate points within a three-dimensional space and it has been used in the medical field for creating a three-dimensional image model on a computer based on a group of tomographic images obtained with an image diagnosis system and obtaining VR images in which the three-dimensional image model is projected onto a two-dimensional plane, without losing the shape information inherent to the three-dimensional image model.

In the VR, a three-dimensional image model of a body to be observed is configured by using an aggregation of image-constituting elements called voxels that are associated with respective signal values obtained by an image diagnosis system, and when the VR image is obtained, the predetermined attributes (referred to hereinbelow as “display properties”) such as color and degree of opaqueness are given to each image-constituting element correspondingly to each signal value (for example, see “MDCT and MRI of Cardiovascular Diseases” (Igaku Shoin), pages 382 to 385)

A curve called “opacity curve” is sometimes used to determine the degree of opaqueness, from among the aforementioned display properties, during imaging (for example, see Japanese Unexamined Patent Publication No. 2000-90283; “Trade Secrets of Three-Dimensional Imaging and Processing Method for Medicine” (Shujunsha)). The opacity curve is usually used for extracting and displaying a region (volume) relating to specific tissues, such as bones, blood vessels, internal organs, and fats, that correspond to a predetermined signal value range from among all the tissues of a body to be observed.

Further, “Trade Secrets of Three-Dimensional Imaging and Processing Method for Medicine” (Shujunsha) describes a technology by which a predetermined color is designated with respect to a voxel that belongs to a signal value band for which the opacity curve has been set, or an opacity curve having a plurality of peaks is set, whereby a VR image in which the specific tissue is color display is obtained. Japanese Unexamined Patent Publication No. 2000-90283 describes a technology by which an opacity curve is set with respect to a voxel that belongs to a region of interest within the image, this opacity curve being different from the curves set for voxels that belong to other regions.

However, in actual medical situations, the state of the affected area is in most cases clarified and the presence of tumor is determined by using a monochromatic two-dimensional image (referred to hereinbelow as original image for observations) that is created based on the signal values obtained with a medical diagnosis system.

However, in such original image for observations, the difference in picked-up signal values between the tissues is represented as a difference in image density values. The resultant problem is that the tissues with signal value ranges that are disposed closely to each other are difficult to distinguish even for a doctor technician (referred to hereinbelow as “doctor and the like”) with sufficient experience in image diagnosis. In particular, the tissues are especially difficult to identify in regions in which the signal value ranges overlap (referred to hereinbelow as “signal value duplication region”), but tumors or the like are sometimes developed in such signal value duplication regions. Further, to which signal value range a predetermined tissue belongs is somewhat affected by individual differences or image pick-up conditions.

If it were possible to create an image (will be referred to hereinbelow as an “image for enabling discrimination”) that can display clearly the difference even between the regions in which signal value ranges are close to each other, can also display clearly this region even with respect to a signal value duplication region, and enables easy adjustment of the region to be displayed and the display state thereof based on the signal value range, it would be very useful for doctors and the like during image diagnosis.

It seems to be useful to apply the technology that is used in the above-described VR, in particular a technology of imaging by providing display properties such as a degree of opaqueness and color to a voxel associated with a signal value, to the process of creating such an image for enabling discrimination.

However, the existing techniques are insufficient for obtaining an image for enabling discrimination that satisfies the requirements of medical circumstances. For example, as described above, the conventional opacity curves are used exclusively for extracting image regions corresponding to specific signal value ranges, and only one opacity curve can be set for one image region. For this reason, they are not suitable for use with the object of displaying regions in which signal value ranges are close to each other or partially overlap, so that such regions can be distinguished from one another.

### SUMMARY OF THE INVENTION

The present invention was created with the foregoing in view and it is an object thereof to provide a medical image generating method that can generate an image for enabling discrimination such that can display clearly the difference between regions in which signal value ranges are close to each other or the presence of a signal value duplication region within a predetermined image region of an observation image and enables easy adjustment of the region to be displayed and the display state thereof based on the signal value range.

The medical image generating method in accordance with the present invention is a method in which a predetermined observation image is generated based on distribution data of signal values associated with a plurality of image-constituting elements constituting a three-dimensional image model of a body to be observed and the observation image is displayed on a predetermined image display portion, the method comprising:

specifying a first image-constituting element group contained in a region to be observed designated in a first observation image that is displayed on a first image display portion, from among the plurality of image-constituting elements;

setting and displaying, on a coordinate system on a second image display portion, a display property curve serving to establish a relationship between respective signal values associated with the first image-constituting element group and display properties to be provided to the first image-constituting element group;

converting an image located in the region to be observed in the first observation image into a display image in which the display properties are reflected, by providing the display properties established by the display property curve to the first image-constituting element group and displaying the converted image,

setting and displaying a plurality of separate and mutually independent display property curves on a coordinate system; and

reflecting at once, in an image within the region to be observed, the display property established by any number of display property curves, from among the plurality of display property curves that are set in the coordinate system.

Further, the medical image generating method according to the invention, setting of the display property comprises setting and displaying any number of display property curves, from among the plurality of display property curves, in a state of mutual overlapping on the coordinate system.

In the medical image generating method according to the invention, the display property is a color and a degree of opaqueness.

Further, the medical image generating method according to the invention, setting of the display property comprises changing a position or shape on the coordinate system with respect to a specific display property curve from among the plurality of display property curves.

Moreover, the medical image generating method according to the invention, setting of the display property comprises moving the plurality of display property curves simultaneously in the coordinate system.

Further, in the medical image generating method according to the invention, the first observation image is any from among a coronal tomographic image, an axial tomographic image, a sagittal tomographic image, and a volume rendering image of the body to be observed.

Further, in the medical image generating method according to the invention, the designation of the region to be observed in the first observation image is performed by inputting the central position and a diameter of the region to be observed via predetermined input means.

Still further, in the medical image generating method according to the invention, the signal values are CT values.

In addition, a medical image generating method for generating a predetermined observation image based on distribution data of signal values associated with a plurality of image-constituting elements constituting a three-dimensional image model of a body to be observed and displaying the observation image on a predetermined image display portion, the method comprising the steps of:

a step of specifying a first image-constituting element group contained in a region to be observed designated in a first observation image that is displayed on a first image display portion, from among the plurality of image-constituting elements;

a step of setting and displaying, on a coordinate system displayed on a second image display portion, a display property curve serving to establish a relationship between respective signal values associated with the first image-constituting element group and display properties to be provided to the first image-constituting element group; and

a step of converting an image located in the region to be observed in the first observation image into a display image in which the display properties are reflected, by providing the display properties established by the display property curve to the first image-constituting element group and displaying the converted image,

wherein these steps are implemented in the order of description, wherein
in the step of setting and displaying, a plurality of separate and mutually independent display property curves which are set and displayed on the coordinate system; and
in the step of converting, the display property established by any number of display property curves from among the plurality of display property curves that are set in the coordinate system are at once reflected in an image within the region to be observed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block-diagram of a medical image generating device of one embodiment;

FIG. 2 illustrates a configuration example of a screen displayed by the device shown in FIG. 1;

FIG. 3 is a flowchart illustrating the sequence of steps of the medical image generating method of one embodiment;

FIG. 4 is a setting example of a plurality of display property curves;

FIG. 5 shows an image before the respective display properties determined by a plurality of display property curves are reflected therein;

FIG. 6 shows an image in which the respective display properties determined by a plurality of display property curves have been reflected at once;

FIG. 7 shows an image in which only the display properties determined by a selected display property curves have been reflected;

FIG. 8 shows another image before the respective display properties determined by a plurality of display property curves are reflected therein; and

FIG. 9 shows another image in which the display properties determined by a plurality of display property curves have been reflected at once.

### DESCRIPTION OF THE PREFERRED EMBODIMENTS

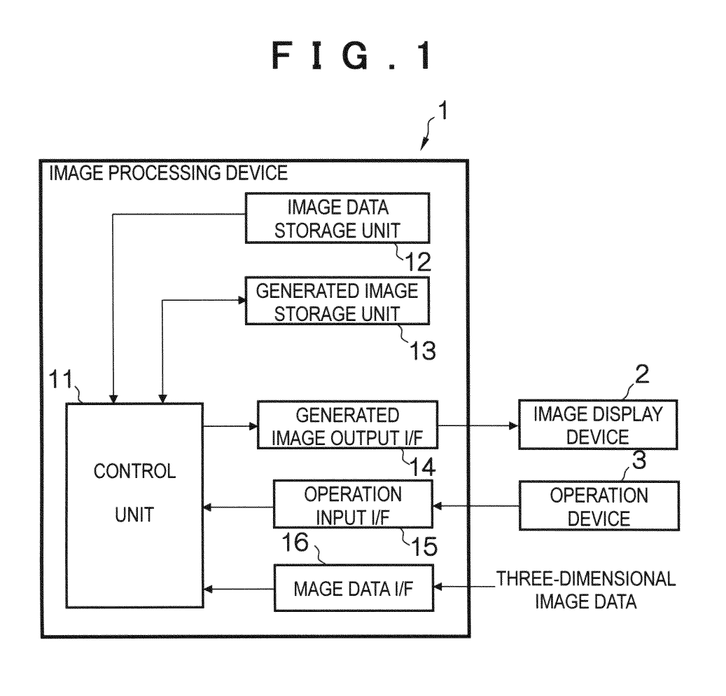

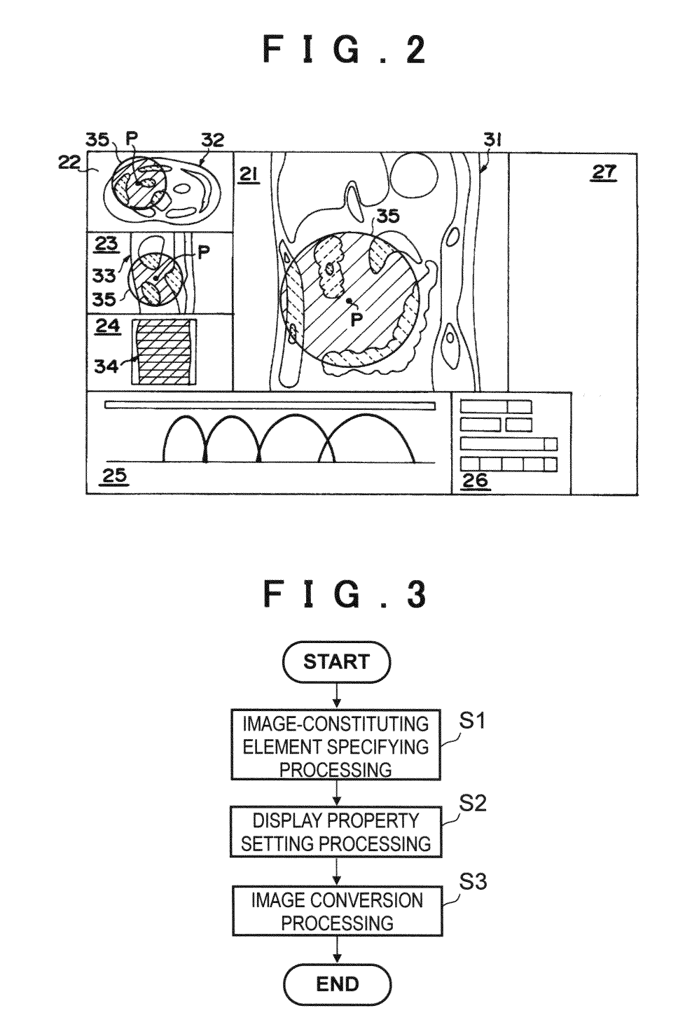

The embodiments of the present invention will be described below in greater detail with reference to the appended drawings. FIG. 1 is a block-diagram illustrating the configuration of the discrimination image generating device for a biological tissue of one embodiment of the present invention. FIG. 2 illustrates a configuration example of a screen displayed by the image display device shown in FIG. 1.

The discrimination image generating device for a biological tissue shown in FIG. 1 generates and displays a predetermined observation image suitable for image diagnosis based on three-dimensional image data for the body to be observed that are obtained with an image diagnosis system such as CT, MRI, and nuclear medicine. This device comprises an image processing device 1 comprising a computer or the like, an image display device 2 having a display screen comprising a liquid display panel or the like, and an operation device 3 comprising a mouse, a keyboard, or the like.

The image processing device 1 comprises a control unit 11 composed of a CPU that performs a variety of computations, a storage device such as a RAM ROM, and a control program stored in the storage device, an image data storage unit 12 that stores three-dimensional image data on a body (for example, a human body) that is observed, those image data being obtained with an image diagnosis system, and a generated image storage unit 13 that stores the image subjected to image processing. Further, the image processing device also comprises a generated image output interface (I/F) 14 that outputs the image subjected to image processing to the image display device 2, an operation input interface (I/F) 15 that transmits a variety of operation inputs from the operation device 3 to the control unit, and an image data interface (I/F) 16 that transmits three-dimensional image data relating to the inside of the living body and inputted via communication means or storage medium to the control unit 11.

The three-dimensional image data are distribution data of signal values (for example, CT values obtained with a CT device or signal intensities obtained with a MRI device) that are respectively associated with a plurality of image-constituting elements (for example, voxels) constituting a three-dimensional model of the body to be observed. The image processing device 1 is configured so as to be capable of generating various observation images (for example, axial tomographic images, coronal tomographic images, sagittal tomographic images, and VR images) relating to the body to be observed based on the distribution data and displaying the observation images on the image display device 2.

A medical image generating program relating to one embodiment of the present invention and serves to execute the below-described types of processing in the image processing device 1 is stored in the storage device located in the control unit 11. The image-constituting element specifying means, display property setting means, and image converting means in the device of the present embodiment are configured of the control unit 11 that executes this medical image generating program.

The image-constituting element specifying means specifies a first image-constituting element group contained in a region to be observed designated in a first observation image that is displayed on a first image display portion of the image display device 2, from among the plurality of image-constituting elements. The display property setting means sets and displays a display property curve serving to establish a relationship between signal values associated with the first image-constituting element group and display properties to be provided to the first image-constituting element group on a coordinate system displayed on a second image display portion of the image display device 2 and can set and display a plurality of separate and mutually independent display property curves on the coordinate system.

The image conversion means converts an image located in the region to be observed in the first observation image into a display image in which the display properties are reflected, by providing the display properties established by the display property curve to the first image-constituting element group and displaying the converted image. The image conversion means can reflect at once, in an image within the region to be observed, the display property established by any number of display property curves, from among the plurality of display property curves.

On the other hand, as shown in FIG. 2, in the image display device 2, a plurality (seven in FIG. 2) of image display portions 21 to 27 that are separated from each other are displayed on one screen. The image display portion 21 in the center of the screen constitutes the first image display portion, and a coronal tomographic image 31 is displayed as a first observation image in this image display portion 21. An axial tomographic image 32, a sagittal tomographic image 33, and a VR image 34 that are generated by the image processing device 1 are respectively displayed on three image display portions 22, 23, and 24 arranged in the vertical direction at the left side of the screen.

An image display portion 25 located in the lower left corner of the screen constitutes the second image display portion. A plurality of mutually independent display property curves that are set by the display property setting means are displayed on the image display portion 25. A variety of input buttons (described hereinbelow in greater detail) that serve for setting the plurality of display property curves are displayed as images in an image display portion 26 that is located at the right side of the image display portion 25 adjacently thereto. A variety of input buttons (not shown in the figure) for performing various other input operations (for example, designating the region to be observed on the coronal tomographic image 31 displayed on the image display portion 21 or changing the dispositions of the image display portions 21 to 24) are displayed as images in an image display portion 27 positioned at the right side of the screen.

A medical image generating method of the present invention will be explained below. FIG. 3 is a flowchart illustrating the sequence of steps of the medical image generating method of one embodiment of the present invention. The medical image generating method of the present embodiment is performed using the medical image generating device shown in FIG. 1.

First, an image-constituting element specifying processing is implemented (step S1 in FIG. 3). In the image-constituting element specifying processing, a first image-constituting element group contained in a region 35 of interest (equivalent to a region to be observed; see FIG. 2) designated in the coronal tomographic image 31 that is displayed on the image display portion 21 of the image display device 2 is specified from among the plurality of image-constituting elements. In the method of the present embodiment this processing is performed with the above-described image-constituting element specifying means.

The designation of the region 35 of interest is performed by a predetermined input operation by an operator such as a doctor. For example, the region 35 of interest can be designated by inputting the central position P of the region 35 of interest on the coronal tomographic image 31 shown in FIG. 2 with a mouse or the like and inputting the diameter of the region 35 of interest with an input button (not shown in the figure) displayed at the image display portion 27 or a keyboard. This region 35 of interest is set as a spherical region in a three-dimensional coordinate system corresponding to a three-dimensional model of the body to be observed, and the first image-constituting element group positioned inside this sphere is specified by the image-constituting element specifying means from among the plurality of image-constituting elements. The region 35 of interest is displayed as a region inside a circle on the coronal tomographic image 31. Further, on the axial tomographic image 32 or the sagittal tomographic image 33, the region 35 of interest is also displayed as a region inside a circle in a position corresponding to the position on the coronal tomographic image 31.

The display property setting processing is then performed (step S2 in FIG. 3). In the display property setting processing, a display property curve serving to establish a relationship between signal values associated with the first image-constituting element group and display properties (a color and a degree of opaqueness) to be provided to the first image-constituting element group is set and displayed on a coordinate system displayed on the image display portion 25. In the method of the present embodiment this processing is performed with the above-described display property setting means. The operation of the display property curve and a method for setting and designating thereof will be described below.

The image conversion processing is then performed (step S3 of FIG. 3). In the image conversion processing, an image located in the region 35 of interest in the coronal tomographic image 31 is converted into a display image in which the display properties are reflected, by providing the display properties established by the display property curve to the first image-constituting element group and displaying the converted image. In the method of the present embodiment this processing is performed with the above-described image converting means.

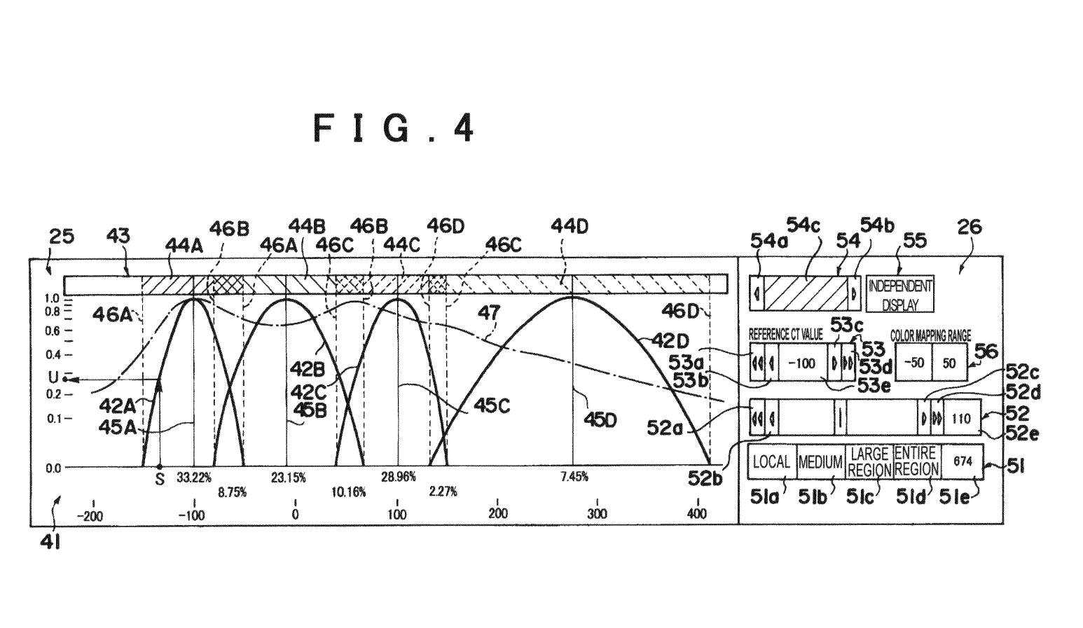

The operation of the display property curve and a method for setting and designating thereof will be described below with reference to FIG. 4. FIG. 4 shows a setting example of a plurality of display property curves.

In the image display portion 25 shown in FIG. 4, a two-dimensional system 41 of coordinate in which a CT value is plotted against the abscissa and the degree of opaqueness is plotted against the ordinate is displayed as the aforementioned system of coordinate. At the ordinate of the system 41 of coordinate shown in FIG. 4, the distance between the marks of the scale are set to decrease gradually in the upward direction. Further, the range of CT values displayed on the abscissa of the coordinate system 41 can be changed appropriately by operating, via a mouse or the like, the input buttons 51, 52 displayed on the image display portion 26.

Thus, four operation portions 51a to 51d that are displayed as “Local”, “Medium”, “Large-region”, and “Entire region”, respectively, are set at the input button 51, and the configuration is such that the size of the range of CT values displayed on the abscissa can be switched to four stages by selecting any of these operation portions 51a to 51d, e.g., by clicking a mouse. The selected range of CT values is displayed at the display portion 51e (“674” in FIG. 4). Further, the input button 51 also serves to set the central value of the selected range of CT values, and the configuration is such that the central value of the range of CT values can be set by operating, e.g., via a mouse, any of the four operation portions 52a to 52d in which triangular marks indicating the movement direction are displayed. The set central value is displayed on the display portion 52e (“110” in FIG. 4).

Four separate mutually independent display property curves 42A to 42D are displayed on the image display portion 25 shown in FIG. 4. These display property curves are set by the display property setting means based on the predetermined setting and designating operation performed by an operator such as a doctor. Here, the setting and designating method will be explained with respect to the display property curve 42A as an example.

First, a reference CT value to be associated with the display property curve 42A is designated from among the entire range of CT values displayed on the abscissa of the coordinate system 41. The designation of the reference CT value is performed by operating the operation portions 53a to 53d that are set in the input button 53 displayed on the image display portion 26 with a mouse or the like, and the designated reference CT value is displayed on the display portion 53e (“−100” in FIG. 4).

Where the reference CT value is designated, the display property curve 42A of a preset shape (for example, normal distribution) is set and displayed with the display property setting means on the coordinate system 41 of the image display portion 25. Further, a first color 44A (for example, yellow) that has been preset for the display property curve 42A is displayed on a color scale 43 that is displayed on the image display portion 25. When the display property curve 42A is displayed, a central line 45A (shown by a solid line in the figure) showing the position of the reference CT value on the coordinate system 41 and two boundary lines 46A (shown by broken lines in the figure) showing the positions of respective two ends of the display property curve 42A are simultaneously shown in the image display portion 25.

Positions of both ends of the display property curve 42A are then designated. The designation of the positions of both ends is performed by moving the boundary lines 46A displayed on the image display portion 25 by a predetermined operation via a mouse or the like. The CT values corresponding to the designated positions of both ends are displayed on a display portion 56 displayed on the image display portion 26 (“−50” and “50” in FIG. 4). Once the designation of the positions of both ends has been performed, the display property curve 42A whose shape has been changed accordingly is set by the display property setting means and displayed on the image display portion 25. In the case where the shape of the display property curve 42A that has been set does not change and only the position thereof on the coordinate system 41 changes, the designation can be performed by moving the central line 45A displayed on the image display portion 25 via a mouse or the like.

The display property curve 42A establishes the relationship between the image-constituting element group having CT values within a range of from −50 to 50, from among the plurality of image-constituting elements, and the first color 44A and the degree of opaqueness thereof that are provided to the image-constituting element group. Thus, the relationship is so established that in FIG. 4 the first color 44A is provided at a ratio of a degree of opaqueness of 1.0 (completely opaque) to the image-constituting element having a CT value of −100 that is a reference CT value of the display property curve 42A, the first color 44A is provided at a ratio of a degree of opaqueness of 0.0 (completely transparent) to the image-constituting elements having CT values of −50 and 50 that are the boundary values at both ends, and the degree of opaqueness designated by the shape of the display property curve 42A, that is the degree of opaqueness that is indicated by the U point in the figure is provided to the image-constituting elements having intermediate CT values, for example, the CT value indicated by the S point.

Other display property curves 42B to 42D are set similarly to the display property curve 42A and demonstrate identical operation. A second color 44B (for example, blue), a central line 45B, and a boundary line 46B correspond to the display property curve 42B, a third color 44C (for example, pink), a central line 45C, and a boundary line 46C correspond to the display property curve 42C, and a fourth color 44D (for example, scarlet), a central line 45D, and a boundary line 46D correspond to the display property curve 42D.

These display property curves 42A to 42D are independent from each other, and a specific curve can be moved or shape thereof can be changed in the coordinate system 41. Where the display property curves 42A to 42D are moved or shapes thereof are changed, the color and degree of opaqueness provided to each image-constituting element by the display property setting means change, and the display state of the image within the region 35 of interest (see FIG. 2) generated by the image conversion means changes accordingly. These changes take place almost simultaneously. Thus, by performing a designation operation that changes the position or shape of the display property curves 42A to 42D on the coordinate system 41, the operator, e.g. a doctor, can instantaneously distinguish the changes in the display state of the image within the region 35 of interest.

All the display property curves 42A to 42D can be also moved simultaneously parallel to each other on the coordinate system 41. A conventional technology is known in which a separate opacity curve is applied to each volume and the generated images are synthesized together to obtain a single observation image, but adjusting the display state in the observation image obtained with such conventional technology is extremely difficult because respective opacity curves that are set for each image of each volume have to be adjusted separately and the images after the adjustment have to be synthesized again. By contrast, in accordance with the present invention, by moving all the display property curves 42A to 42D simultaneously parallel to each other on the coordinate system 41, it is possible to perform full adjustment of the display state of the image within the region 35 of interest. Moreover, because this adjustment can be performed, while visually confirming the changes in the display state of the image within the region 35 of interest, the adjustment can be performed very easily.

This function is expected to be useful in image diagnosis. For example, there are cases where an observation zone, such as tumor, that is present in the region 35 of interest and is difficult to distinguish in the initial image state can be easily identified by changing the image state, for example, by moving the display property curves 42A to 42D.

The display property established by the display property curves 42A to 42D is usually reflected at once in the image-constituting element within the region 35 of interest, but it is also possible to reflect only the display properties established by any number of curves from among the display property curves 42A to 42D. For example, as shown in FIG. 4, input buttons 54, 55 for designation are so set in the image display portion 26 that one curve is selected from among the display property curves 42A to 42D and only the display properties established by this selected curve are reflected. The input button 54 enables the selection of one curve from among the display property curves 42A to 42D by operating the operation portions 54a, 54b thereof with a mouse or the like (in FIG. 4, discrimination is made by the color displayed on the display portion 54c). When only the display properties established by the selected display property curve are wished to be reflected, as represented by “Independent display”, the input button 55 is operated via a mouse or the like.

Further, in FIG. 4, the mutually adjacent curves from among the display property curves 42A to 42D are set so as to overlap partially (they can be also set so as not to overlap). Colors obtained by mixing colors corresponding to two mutually adjacent display property curves 42A and 42B, 42B and 42C, and 42C and 42D are provided to the image-constituting elements having respective CT values in the overlapping ranges. For example, a color (for example, green) obtained by mixing the first color 44A and the second color 44B is provided to the image-constituting elements having respective CT values within a range in which the display property curves 42A and 42B mutually overlap.

Such overlapping function is expected to be very useful in image diagnosis. For example, there are cases in which a tumor or the like is discovered in a region in which CT values overlap between different tissues, but by setting a plurality of display property curves so that they overlap sometimes makes it possible to grasp the regions corresponding to the tumor or the like by visibly color separating them from the surrounding tissue.

Other functions in the present embodiment will be described below. As shown in FIG. 4, a histogram 47 is displayed on the coordinate system 41 displayed on the image display portion 25. This histogram 47 shows a frequency distribution of respective CT values associated with image-constituting elements located within the region 35 of interest (see FIG. 2).

Further, the ratio of the image-constituting elements having CT values within the ranges corresponding to respective display property curves 42A to 42D in all the image-constituting elements within the region 35 of interest is described with numerals in the image display portion 25. For example, “33.22%” is presented below the central line 45A of the display property curve 42A. This numeral means that the image-constituting elements having CT values (−50 to 50) within a range corresponding to the display property curve 42A take 33.22% of all the image-constituting elements within the region 35 of interest. Further, “8.75%” is presented below a portion in which the display property curves 42A, 42B overlap. This numeral indicates that the image-constituting elements having CT value between a position where the boundary line 46A on the right side of the display property curve 42A is set and the position indicated by the boundary line 46B on the left side of the display property curve 42B take 8.75% of all the image-constituting elements within the region 35 of interest. These numeral values indicate a volume ratio of each tissue corresponding to each respective CT value range within the region 35 of interest, and whether the tissue is a tumor or a blood vessel or an internal organ sometimes can be determined by this numerical value.

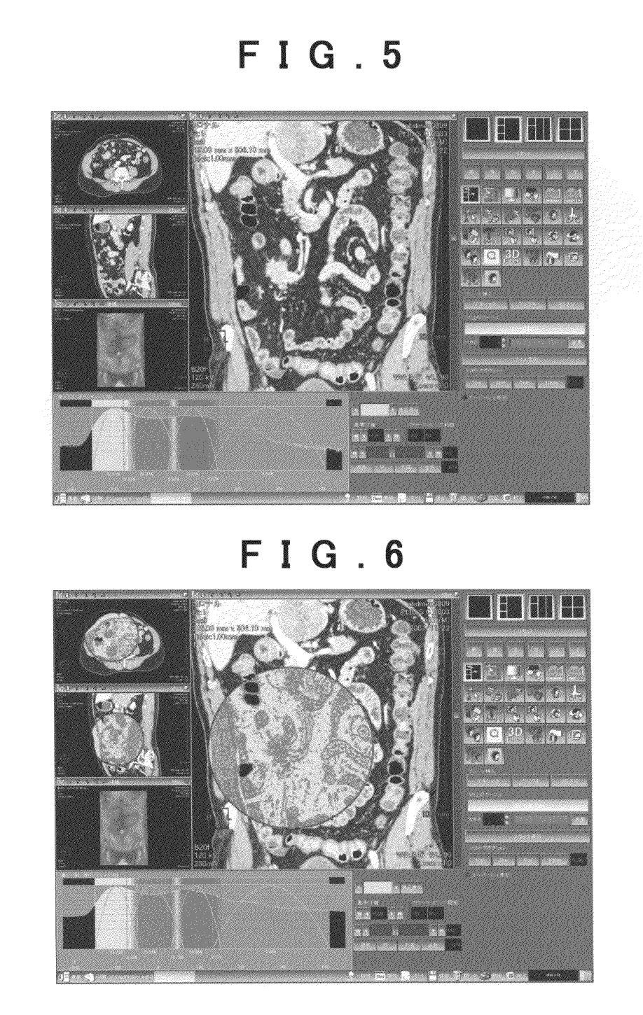

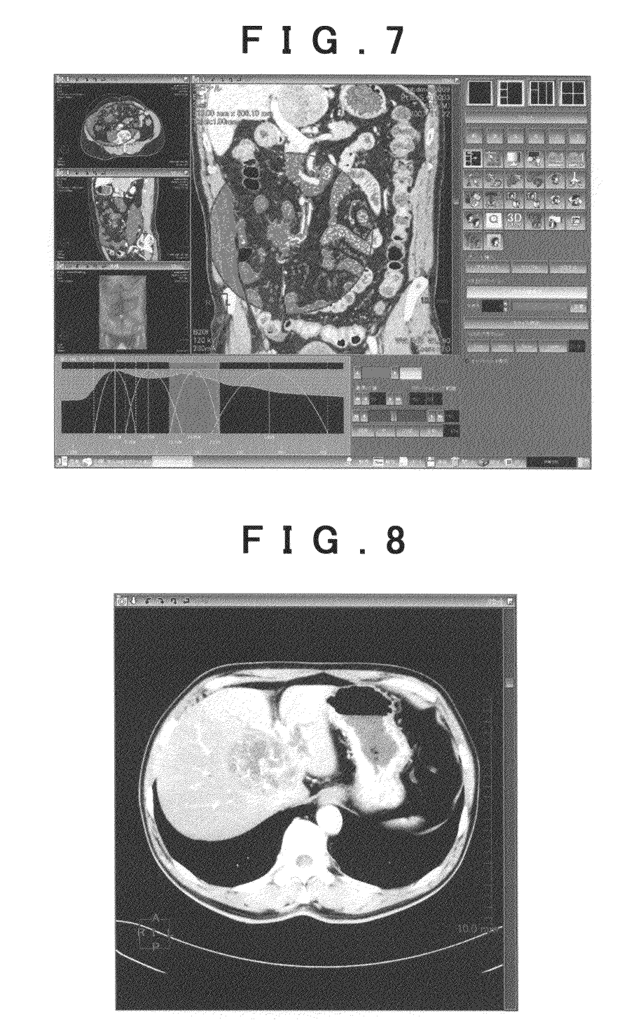

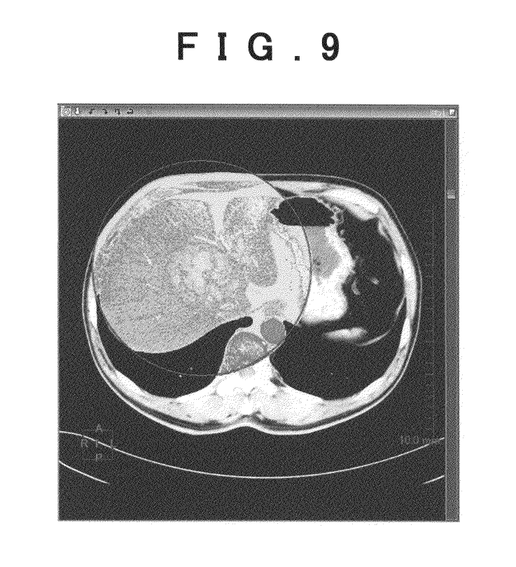

FIG. 5 to FIG. 9 show the images generated by applying the present invention. FIG. 5 shows an image before the respective display properties established by a plurality of display property curves are reflected, and FIG. 6 shows an image in which the respective display properties have been reflected at once. FIG. 7 shows an image in which only the display properties established by one selected display property curve have been reflected. FIG. 8 shows an axial tomographic image before the respective display properties established by a plurality of display property curves are reflected, and FIG. 9 describes an axial tomographic image in which the respective display properties have been reflected at once.

These images are actually color images, and it is obvious that they enable a clear and accurate recognition of the presence of a region in which the signal value ranges are close to each other or overlap within the predetermined image region by the difference in the displayed colors.

An embodiment of the present invention is described above, but the present invention is not limited to this embodiment and can be changed in a variety of ways.

For example, in the embodiment above, the region 35 of interest is set and displayed in the coronal tomographic image 31, axial tomographic image 32, and sagittal tomographic image 33, but the region 35 of interest may be also set and displayed in any other tomographic image (not shown in the figures) or the VR image 34.

In the embodiment above, the shapes of the display property curves 42A to 42D are assumed to be preset, but it is also possible to enable the free-hand setting of any shape.

Further, the present invention is especially useful in the case in which three-dimensional image data obtained with a CT image diagnosis system are used, but can be also applied to the case in which image data obtained by other image diagnosis system such as MRI and radiation medicine are used.

In accordance with the present invention, a plurality of separate and mutually independent display property curves can be set, and display properties such as color or degree of opaqueness that are established by any number of the display property curves from among the plurality of display property curves that have been set can be at once reflected in the images within a region to be observed. Therefore, the following effect is demonstrated.

Thus, even in the case in which a plurality of tissues for which the signal value ranges are located close to each other or partially overlap within the region to be observed are present, a plurality of separate and mutually independent display property curves can be set to be located close to each other or partially overlap so as to conform to each signal value range corresponding to each respective tissue. Therefore, image regions corresponding to each of a plurality of tissues or image regions corresponding to a portion in which the signal value ranges overlap can be clearly displayed.

Further, by using a plurality of display property curves to be set that are separate from each other and mutually independent, it is possible to move, or to change the shape of, only a specific display property curve on the coordinate system with respect to other display property curves. Therefore, by performing such operation, it is possible to adjust partially the region displayed on the image or a display state thereof in an easy manner.

Furthermore, all the display property curves can be moved simultaneously parallel to each other on the system of coordinate, and in this case the region displayed on the image or a display state thereof can be easily adjusted as whole.

Therefore, a doctor can easily recognize the presence of a region in which signal value ranges are close to each other or partially overlap within a predetermined image region, thereby effectively aiding the diagnosis performed by the doctor.

What is claimed is:

1. A medical image generating method in which a predetermined observation image is generated based on distribution data of signal values associated with a plurality of image-constituting elements constituting a three-dimensional image model of a body to be observed and the observation image is displayed on a predetermined image display portion, the method comprising:
specifying a first image-constituting element group contained in a region to be observed designated in a first observation image that is displayed on a first image display portion, from among the plurality of image-constituting elements;
setting and displaying, on a coordinate system on a second image display portion, a display property curve serving to establish a relationship between respective signal values associated with the first image-constituting element group and display properties to be provided to the first image-constituting element group;
converting an image located in the region to be observed in the first observation image into a display image in which the display properties are reflected, by providing the display properties established by the display property curve to the first image-constituting element group and displaying the converted image,
setting and displaying a plurality of separate and mutually independent display property curves on a coordinate system; and
reflecting at once, in an image within the region to be observed, the display property established by any number of display property curves, from among the plurality of display property curves that are set in the coordinate system.

2. The medical image generating method according to claim 1, wherein setting of the display property comprises setting and displaying any number of display property curves, from among the plurality of display property curves, in a state of mutual overlapping on the coordinate system.

3. The medical image generating method according to claim 1, wherein the display property is a color and a degree of opaqueness.

4. The medical image generating method according to claim 1, wherein setting of the display property comprises changing a position or shape on the coordinate system with respect to a specific display property curve from among the plurality of display property curves.

5. The medical image generating method according to claim 1, wherein setting of the display property comprises moving the plurality of display property curves simultaneously in the coordinate system.

6. The medical image generating method according to claim 1, wherein the first observation image is any from among a coronal tomographic image, an axial tomographic image, a sagittal tomographic image, and a volume rendering image of the body to be observed.

7. The medical image generating method according to claim 1, wherein the designation of the region to be observed in the first observation image is performed by inputting the central position and a diameter of the region to be observed via predetermined input means.

8. The medical image generating method according to claim 1, wherein the signal values are CT values.
